(19) United States
(12) Patent Application Publication
(10) Pub. No.: US 2005/0275234 A1
(43) Pub. Date: Dec. 15, 2005

(54) Mobile locker

(76) Inventors: Thomas Ottenthal, Augsburg (DE); Michael Braun, Neusass (DE)

Correspondence Address: HOFFMANN & BARON, LLP, 6900 JERICHO TURNPIKE, SYOSSET, NY, 11791, US

(21) Appl. No.: 11/144,858

(22) Filed: Jun. 3, 2005

(30) Foreign Application Priority Data
Jun. 14, 2004 (DE) 10 2004 028 732.5
Jul. 19, 2004 (DE) 10 2004 034 901.0
Jan. 10, 2005 (DE) 20 2005 000 282.8

(51) Int. Cl. B62C 1/06

(52) U.S. Cl. 296/10

(57) ABSTRACT

The present invention relates to a locker system for temporarily receiving valuables comprising a housing and at least one lockable access opening or at least one locker. The locker system can be arranged on a vehicle and can be transferred from a transport position into an operating position. According to a further embodiment of the invention, the locker system comprises wheels or rolls which are configured in such a manner that in a transport position they allow transport of the locker system (10) and in an operating position they prevent unauthorized transport of the locker system (10). The invention moreover relates to a vehicle comprising one or more locker systems of this kind.

### CROSS-REFERENCE TO RELATED APPLICATIONS

This application is claims the benefit of German Application Nos. DE 10 2004 028 732.5, filed Jun. 14, 2004; DE 10 2004 034 901.0, filed Jul. 19, 2004; and DE 20 2005 000 282.8, filed Jan. 10, 2005, the contents of which are incorporated by reference herein.

### FIELD OF THE INVENTION

The present invention relates to a mobile locker or locker system, in particular for temporarily receiving valuable objects or valuables, as well as a vehicle comprising a locker system of this kind.

### BACKGROUND OF THE INVENTION

U.S. Pat. No. 3,837,300 relates to a receptacle or container which is used in trucks and adapted to receive a cart. The receptacle comprises a housing having a rear door through which the cart can be placed within and removed from the receptacle. The cart includes a plurality of receptacle compartments arranged in rows, and the front side of the housing includes a plurality of rows of doors which can be aligned sequentially with respect to the receptacle compartments.

Lockers have been known for a long time and are usually provided permanently mainly in railway stations, airports or the like public places so that valuables can be deposited in the lockers. These lockers serve their purpose in their place of installation; however, since people take more and more valuable objects such as, e.g., mobile telephones, mobile music players etc. with them, there is a need for being able to safely store these objects, e.g., during big events. In particular during events that are not held on a place that is normally intended therefor, there is an increased need for being able to deposit valuables temporarily.

### SUMMARY OF THE INVENTION

It is the object of the present invention to satisfy this need and to provide a mobile locker system as well as a vehicle comprising a locker system. This object is achieved with the features of the claims.

In achieving this object, the invention starts out from the basic idea to provide a locker system, in particular for temporarily receiving valuables, comprising a housing and at least one lockable access opening. The locker system can be arranged on a vehicle, in particular an automobile trailer, or on the loading area of a van or truck and/or it can be mobile itself, e.g., by rolls or wheels. The locker system is configured in such a manner that it can be transferred or changed from a transport position, in which the locker system is easily transportable, into an operating position, in which the individual lockers of the locker system can be accessed and the locker system is secured against unauthorized removal, and vice versa.

A preferred embodiment of the locker system according to the invention comprises a movable base or foundation for a transfer between the transport and operating positions. This base preferably comprises a plurality of rolls or wheels which guarantee a problem-free transport of the locker system in the transport position. In the operating position of the locker system, the rolls are in a state, e.g. a position, in which it is not possible or at least relatively difficult to move the locker system. To this end, the rolls can be lifted from the ground by means of a lifting mechanism (in a mechanical, electrical, hydraulic, pneumatic, etc. manner). Alternatively or additionally, also the housing of the locker system can be lifted so that the rolls no longer contact the ground; for example, retractable or telescopic sustainers or rests can be provided for this purpose. Moreover, also the rolls themselves can be arrestable and protected from unauthorized access so that a removal of the locker system is avoided.

According to this embodiment of the invention, the locker system itself is mobile and can be transferred from a transport position into an operating position. The rolls or wheels, which are provided in accordance with this embodiment, can be folded out for transferring the locker system from the transport position into the operating position and vice versa. In the operating position, the rolls or wheels are, e.g., folded in, blocked or made temporarily non-operational in any other manner so that the locker system is not mobile. Appropriately, the operating position is secured by means of a latching or closing means against a malicious transfer of the locker system from the operating position into the transport position, so that the locker system cannot be removed from its position by unauthorized persons.

A further embodiment of the locker system according to the present invention, which serves, in particular, for temporarily receiving valuables, comprises a housing and at least a lockable access opening. The locker system is configured as a vehicle, in particular an automobile trailer, in such a manner that it can be transferred from a transport position, in which the locker system is arranged on the vehicle so as to be safely transportable, into an operating position, in which the individual lockers of the locker system can be accessed, and vice versa. In the operating position an unauthorized transport of the automobile trailer is avoided in that, e.g., the trailer is secured against removal by hitching it to another vehicle. For instance, this can be realized by suitable locking means or anchoring measures.

A combination of the above-mentioned embodiments is advantageous, in particular, in that the locker system can be transported on the vehicle over long distances and can then be transported further in the area of the place of use by means of its own rolls or wheels to bring it to the actual place of use. In other words, a locker system of this kind comprises two transport positions and two operating positions: a first transport position on the vehicle and a second transport position for transporting the locker system to its destination. Depending on the kind of use, a locker system of this kind can be transferred on the vehicle into a first operating position, e.g., if the locker system can be brought by means of the vehicle directly to the place of use. If this is not possible or desired, the locker system, after having been transported to the desired place of use, can be transferred into a second operating position, e.g., by folding in and blocking the rolls or wheels.

The locker system preferably comprises a plurality of lockable access openings or lockers which, e.g., can be locked by means of a locking arrangement and activated by inserting a coin or payment of a fee. To this end, a version in which the respective amount is only kept temporarily as a deposit and also a version in which the user is directly liable to costs can be used. The locking arrangement can be realized, e.g., by mechanical or electronic locks or locking systems.

According to an embodiment of the present invention, the housing comprising the one or more lockers is firmly mounted (e.g. by screwing) on a trailer, in particular an automobile trailer, wherein the trailer is secured against unauthorized removal, movement, etc. The trailer can be secured, e.g., by means of a hitching protection on the draw-bar of the trailer, by blocking the brake of the trailer and/or by a support of the trailer that is protected against unauthorized access. Instead of firmly mounting the housing on the trailer, the housing can also be mounted on the trailer by means of a quick acting closure, e.g., a snap-in system or bayonet catch.

If, e.g., an automobile trailer is used for mounting the housing of the lockers thereon, a transfer between the transport position and the operating position can be made, e.g., in that a tarpaulin for the housing is provided which, in the operating position, serves as a cover for the locker system itself and the close vicinity thereof. In particular, said cover can also protect the trailer from unauthorized removal, e.g., by means of suitable locking means or anchoring measures. Alternatively, the locker system according to the present invention can also be mounted on a van or truck.

According to a further preferred embodiment of the locker system according to the present invention, the housing is mounted on the vehicle by means of a rail arrangement so that it can be moved between the transport position and the operating position. This is particularly advantageous if a plurality of locker systems is arranged on the vehicle and these locker systems are pushed together to form a relatively narrow arrangement on the vehicle during transport, while they can be moved apart in the operating position to provide access to all lockers of the locker system. For example, the rail system can be arranged in such a manner that movement is possible transversely and/or longitudinally with respect to the direction of motion of the vehicle. Additionally or alternatively, also a rotating device, e.g., in the form of a plate, can be used for allowing the rotation of the locker system on the vehicle.

Alternatively, the rail arrangement can of course also be provided on the vehicle or on the vehicle and the locker system; to this end, the locker system itself must be configured so as to be able to engage the rail system.

According to a further advantageous embodiment of the locker system according to the present invention, a lifting means can be provided on the locker system for arranging the locker system on the vehicle in such a manner that it can be lowered and lifted. This is particularly advantageous in embodiments in which the locker system has to be separated from the vehicle in the operating position on the desired place of use. However, a lifting means of this kind can also be advantageous for providing easier access to the lockers of the locker system in that the latter can be lowered to the ground by the lifting means. The lifting means can also be provided on the vehicle, wherein in this case the locker system should be configured such that the lifting means can be attached.

An advantageous embodiment of the locker system according to the present invention can comprise a rail arrangement and/or rotating device for arranging the system on a vehicle in a movable and rotatable manner and also a lifting means for at least partially lowering the locker system with respect to the vehicle, so that there is a simple and variable possibility of transferring the locker system from the transport position into the operating position and vice versa.

The locker system itself preferably comprises a box-shaped housing (e.g. in the form of a cuboid, cylinder, barrel, or other three-dimensional configuration being formed by bases having the shape of a circle segment or a polygon). The housing preferably comprises a plurality of access openings located on at least one side of the housing for providing the individual lockers. Preferably, access openings are provided on both the front side of the housing and the rear side of the housing so that the access is as good as possible in the operating position and, at the same time, the locker system can be transferred into a transport position in which its volume is as small as possible. The following materials are preferred for the lockers, in particular the housing: metal (e.g. lacquered or galvanized steel, aluminum, high-grade steel), plastic and/or wood.

Moreover, the present invention relates to a vehicle comprising one or more of the locker systems described above.

### BRIEF DESCRIPTION OF THE DRAWINGS

In the following, preferred embodiments of the locker system according to the present invention will be described with reference to the drawings in which

FIG. 1 is a top view of a first embodiment of a plurality of locker systems according to the present invention being arranged on a trailer, wherein some locker systems are in the transport position and some in the operating position,

FIG. 2 is a top view of a second embodiment of a plurality of locker systems according to the present invention being arranged on a trailer, wherein some locker systems are in the transport position and some in the operating position,

FIG. 3 is a perspective view of a third embodiment of a locker system according to the present invention on a trailer,

FIG. 4 is a perspective view of a fourth embodiment of a locker system according to the present invention with integrated rolls,

FIG. 5 is a perspective view of a further embodiment of a locker system according to the present invention which is similar to that of FIG. 4 and comprises rolls or wheels that can be folded in,

FIG. 6 is a perspective view of a detail of a lifting mechanism of the locker system according to FIG. 5,

FIG. 7 is a perspective view of a detail of a movable base for the locker system according to FIGS. 5 and 6,

FIG. 8 is a perspective view of a further embodiment of the locker system according to the present invention similar to that of FIG. 5 and comprising retractable sustainers, and

FIG. 9 is a perspective view of a detail of the movable base for the locker system according to FIG. 8.

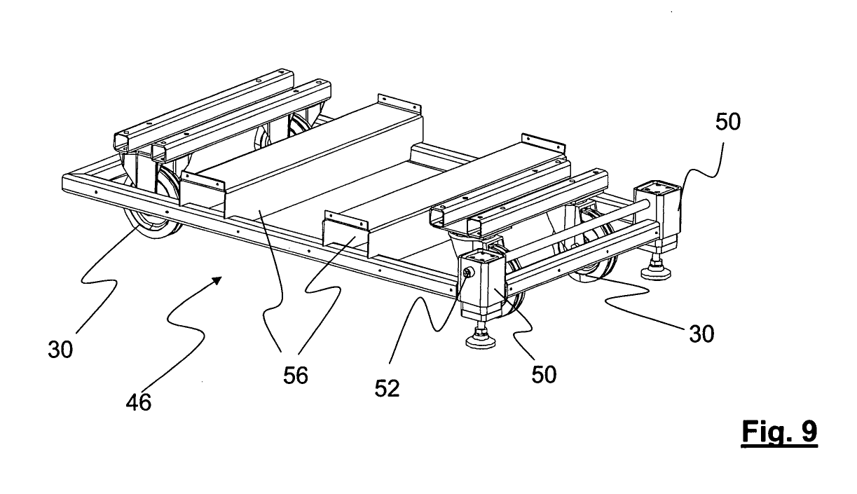

### DETAILED DESCRIPTION OF PREFERRED EMBODIMENTS

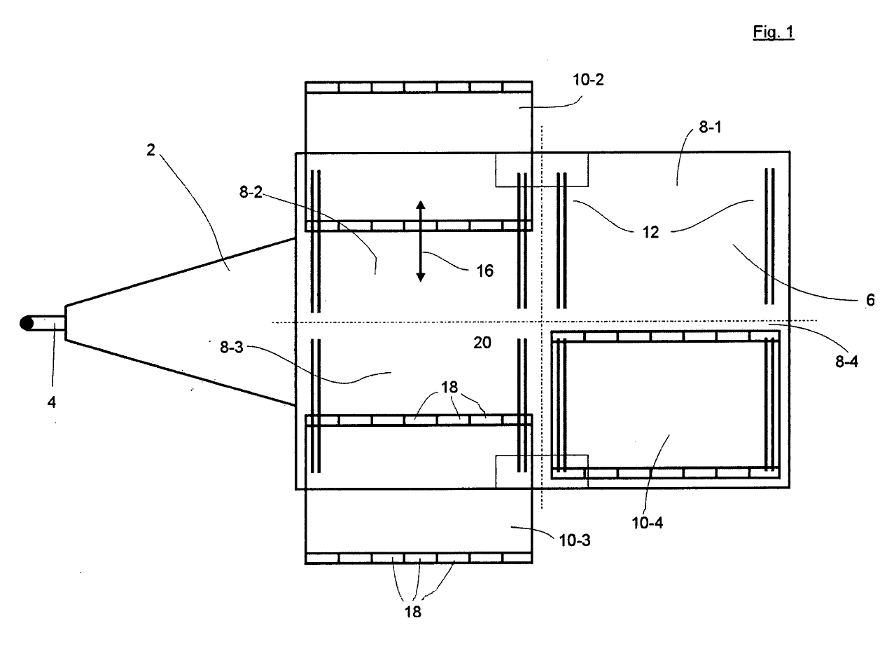

FIG. 1 schematically shows a top view of a vehicle according to the present invention in the form of an automobile trailer 2. The trailer comprises a chassis (not shown in detail) having a draw-bar 4 and a loading area 6. In the embodiment shown in FIG. 1, the loading area 6 comprises four receiving areas 8-1, 8-2, 8-3 and 8-4 for receiving locker systems 10-2, 10-3 and 10-4 according to the present invention. For the sake of clarity, the locker system 10-1 is not shown in FIG. 1 so that the loading area 6 of the trailer 2 is freely visible.

In the embodiment shown in FIG. 1, the locker system 10 according to the present invention is mounted on the trailer 2 by means of a rail means 12 so that the individual lockers are moveable between the transport position and the operating position in a transverse direction with respect to the direction of motion 14 of the trailer. This is shown by arrow 16 in FIG. 1. In the embodiment shown in FIG. 1, the locker system 10-4 is shown in the transport position in which it is arranged completely on the loading area 6 of the trailer 2. The locker systems 10-2 and 10-3 are arranged in their operating positions. By arranging the locker systems 10 on the trailer in a movable manner, the individual lockers or lockable access openings 18 of each locker system can be accessed both from an area outside the trailer 2 and from an access area 20 provided inside. Thus, many lockers can be realized on a small space so that the locker systems 10 are relatively densely packed on the trailer 2 in the transport position whereas the individual locker systems 10 are arranged more spaciously in the operating position to provide access to all lockers 18 of the system.

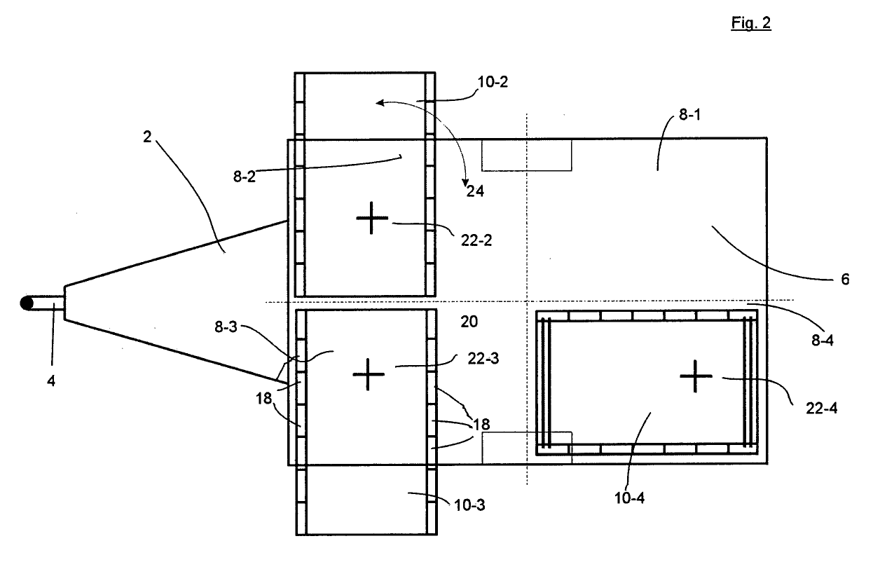

In the embodiment shown in FIG. 2, the locker system according to the present invention can be transferred from the transport position into the operating position by means of the rotating device 22; this is schematically shown for the locker system 10-2 by the arrow 24. The points of rotation of the rotating devices 22 are advantageously selected in such a manner that in the transport position the locker systems are narrowly arranged on the vehicle while in the operating position the individual lockers can be accessed well.

A combination of the embodiments according to FIGS. 1 and 2 is advantageous for guaranteeing a better flexibility in the arrangement of the individual locker systems on the vehicle. In such a combination, thus both rail means 12 and rotating means 22 are provided and guarantee a particularly advantageous variability of the locker system according to the present invention.

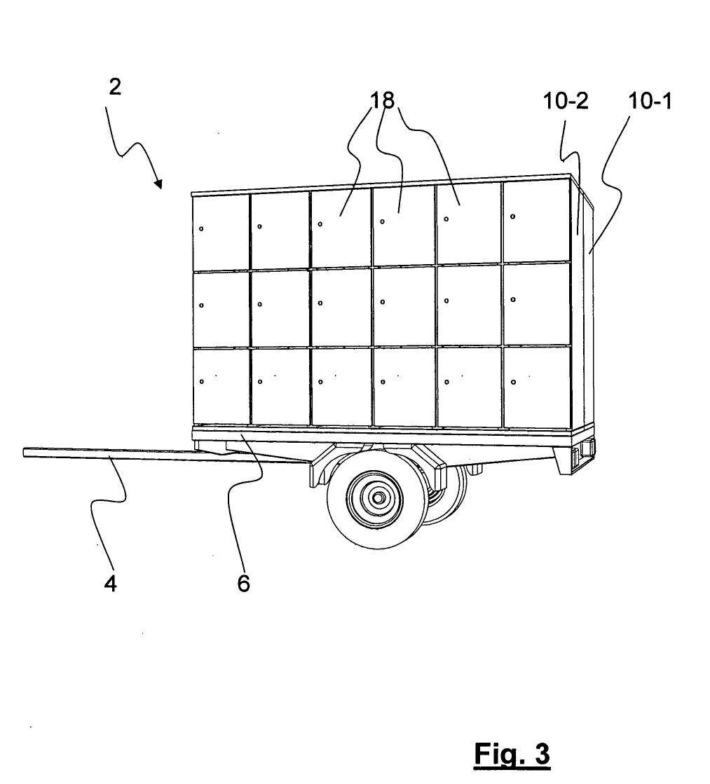

FIG. 3 shows a perspective view of a further embodiment of the locker system according to the present invention. According to this embodiment, the individual lockers 18 are arranged in the form of two units or modules 10-1, 10-2 on the loading area 6 of the trailer 2 either firmly or, e.g., by means of a quick acting closure. The draw-bar 4 of the trailer 2 is preferably secured against unauthorized hitching. Alternatively or additionally, the trailer can be provided with sustainers (not shown) which avoid unauthorized movement of the locker system. In addition or as an alternative, the brake of the trailer can be secured against unauthorized manipulation. Any one of these options per se or in combination is a possibility of transferring the locker system according to the present invention from the transport position into the operating position and vice versa.

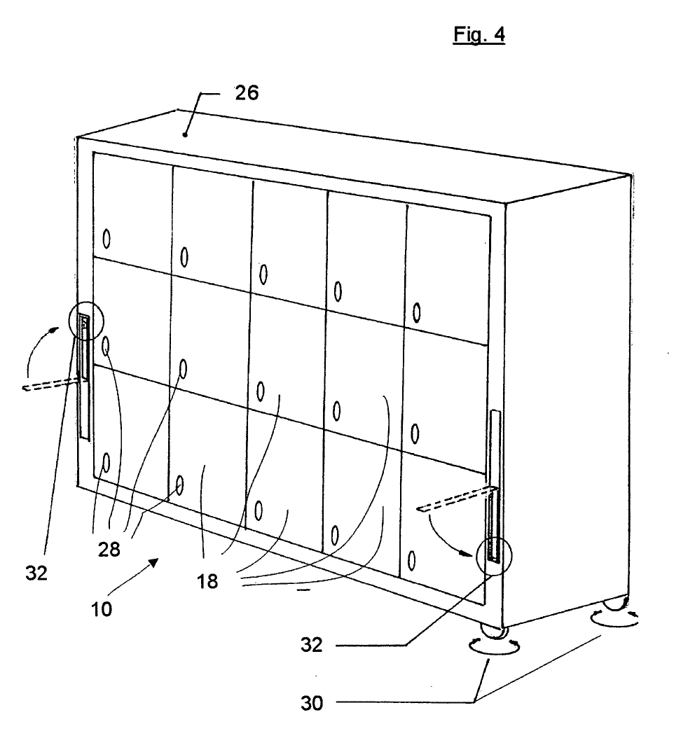

The embodiment of the locker system 10 according to the present invention shown in FIG. 4 is either suitable for being used on a vehicle according to the embodiments shown in FIGS. 1 to 3 or, in particular, can also be used independently without a vehicle.

As shown in FIG. 4, the locker system 10 comprises a housing 26 having a plurality of lockers 18 which can each be locked by a schematically shown lock 28. Moreover, the housing 26 is provided with rolls or wheels 30 allowing an easy transport of the locker system 10. In FIG. 4 the locker system 10 is shown in its transport position in which the wheels 30 are extended from the housing 26. For transferring the locker system 10 into the operating position, the wheels 30 can, e.g., be retracted in or under the housing 26. In the shown embodiment a lever mechanism 32 is used for this purpose. The operating position, in which the wheels are retracted, is preferably secured against unauthorized manipulation by a latching or closing means (not shown). The locker system according to the present invention can thus be easily transported to the desired place of use and placed there safely.

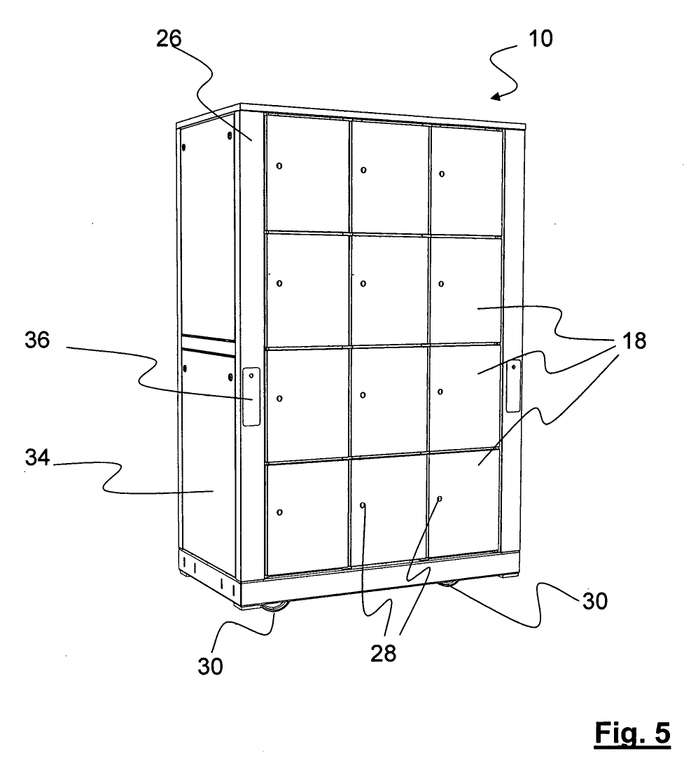

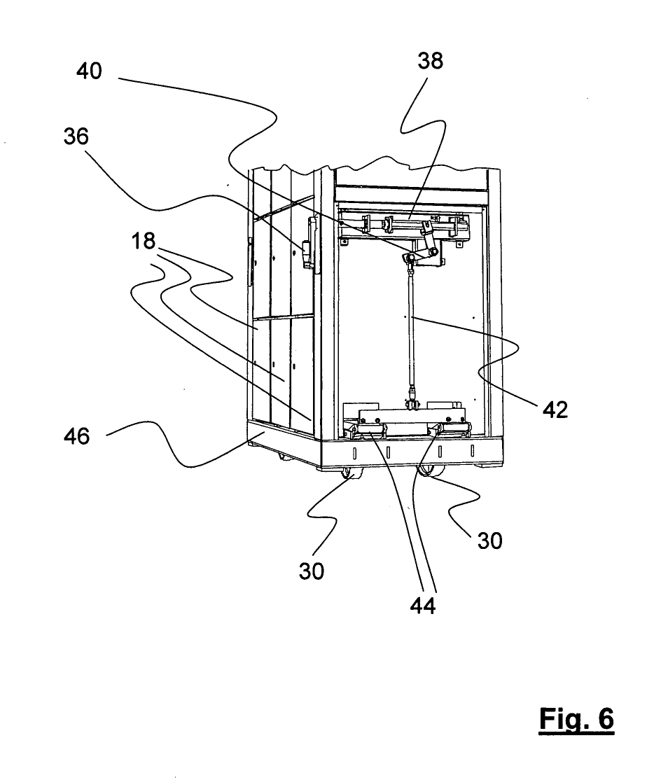

FIGS. 5 to 7 show a further embodiment of a locker system 10 according to the present invention which is, in principle, similar to that of FIG. 4. The locker system 10 shown in FIG. 5 comprises a housing 26 which comprises at least one additional lockable compartment 34 in addition to the individual lockers 18. According to this embodiment, part of the lifting mechanism for the rolls 30 is located in said compartment 34; this is shown in detail in FIG. 6.

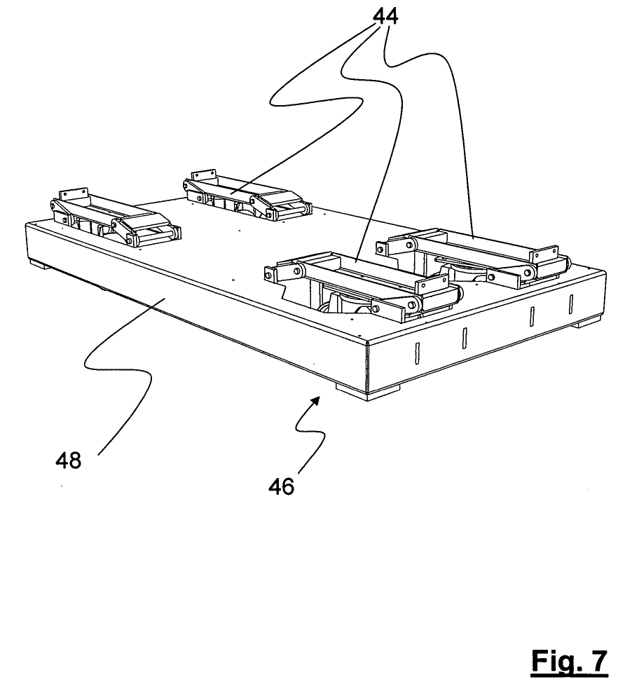

In FIG. 6 the locker system is shown without the lockable cover for the compartment 34. As shown in FIG. 6, the lifting mechanism comprises in particular an actuating crank 36 by means of which the lifting mechanism can be activated for transferring the locker system from the transport position into the operating position and vice versa. Below the cover of compartment 34 there is a toggle 40 which is driven by a threaded spindle 38 and in turn coupled to a connecting rod 42. The connecting rod 42 is connected with a lever mechanism 44 which is shown in detail in FIG. 7 and attached to a base 46. This lever mechanism bears the rolls 30.

Alternatively to the lifting mechanism described above or in addition thereto, it is also possible to bring the rolls 30 into a state, e.g. into a position, in which it is not possible or at least relatively difficult to move the locker system. To this end, the rolls can be blocked, e.g., by a brake. In this case, the actuating means for the brake is provided, e.g., below a lockable cover. This can be realized, e.g., by a foldable skirt or cover 48 (cf. FIG. 7).

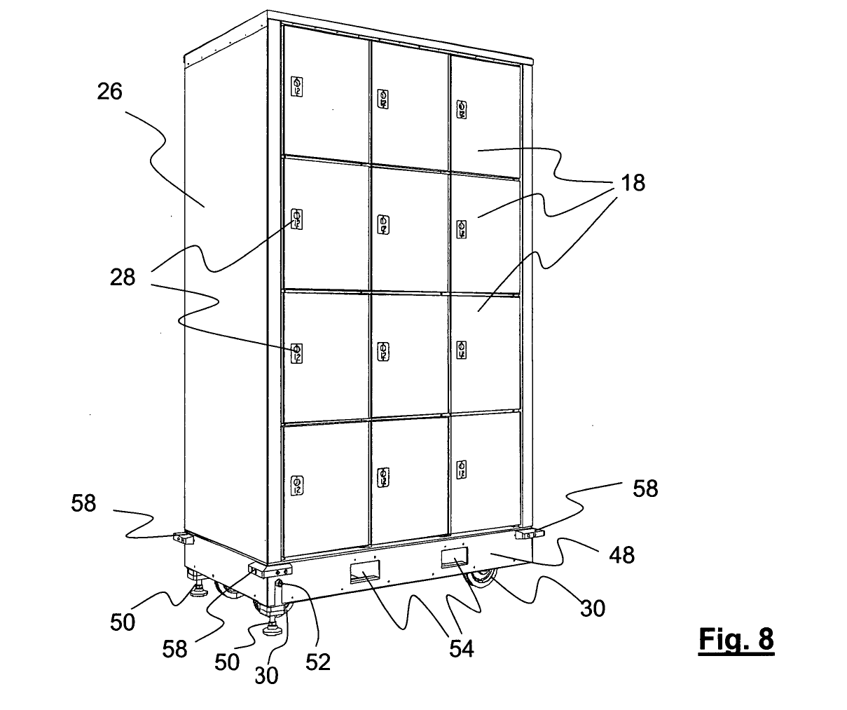

The embodiment of the locker system according to the present invention shown in FIG. 8 comprises extendable and retractable sustainers 50 by means of which the rolls or wheels 30 can be lifted at least partially from the ground to avoid unauthorized movement of the locker system. It is advantageous to provide at least two sustainers 50 of this kind on one side of the housing 26, in particular in the edge region. However, also more sustainers of this kind can be provided, e.g., in each edge region of the housing 26. The entire locker system can thus be lifted from the ground. The sustainers 50 can preferably be actuated by means of a special key which can be inserted in a corresponding lock 52. The sustainers 50 can be extended and retracted by means of the key.

Moreover, it can be preferred to provide the skirt 48 with two pairs of opposite openings 54 which can be engaged by a fork-lift truck to lift the locker system, e.g., onto a trailer or truck. To this end, the base 46 has preferably a receiving and supporting structure 56 on which the locker system can be held by the fork of the fork-lift truck.

Moreover, it is advantageous to provide the locker system, e.g. in the areas of its edges, with a bump protection 58 in the form of rubber buffers to minimize damage during transport of the locker system.

The locker system according to the present invention can be used easily in particular during big events such as concerts, fairs, sport events, on lakes for bathing and the like and it guarantees a safe locking away of valuables. When the event is over, the vehicle comprising the locker system can be easily moved away and provided on the next place of use.

1. A locker system for receiving valuables comprising a housing and at least one lockable access opening (18), wherein the locker system (10) can be transferred from a transport position into an operating position and vice versa.

2. The locker system according to claim 1 which can be moved between the two positions by means of a rail arrangement (12) and/or is arranged on the vehicle (2) in such a manner that it can be lowered or lifted by means of a lifting device and/or can be moved between the two positions by means of a rotating device (22).

3. The locker system according to claim 1, wherein the housing is box-shaped and comprises a plurality of access openings (18), wherein access openings (18) are preferably provided on both a front side of the housing and a rear side of the housing, wherein the access openings (18) provided on the rear side of the housing can only be accessed in the operating position.

4. The locker system according to claim 1, wherein the at least one access opening (18) can be locked by a locking arrangement that can be activated by inserting a coin or payment of a fee.

5. The locker system according to claim 1 which can be arranged on a trailer, in particular an automobile trailer, on the loading area of a van or truck or in the form of containers.

6. The locker system according to claim 1 comprising wheels (30) which are configured in such a manner that in the transport position they allow transport of the locker system (10) and in the operating position they prevent unauthorized transport of the locker system (10).

7. The locker system according to claim 6, wherein the wheels (30) can be lifted from the ground and/or blocked and/or the housing of the locker system (10) can be lifted in such a manner that the wheels can be separated from the ground, and/or a brake is provided.

8. The locker system according to claim 6, wherein the wheels or the housing can be transferred from the transport position into the operating position and vice versa by means of a lever mechanism (32) or a lifting mechanism.

9. The locker system according to claim 8, wherein the lever or lifting mechanism can be latched and/or locked.

10. The locker system according to claim 8, wherein the lifting mechanism comprises a crank (36) for driving a threaded spindle (38), a toggle (40) being connected with the threaded spindle (3 8) and a connecting rod (42), as well as a lever mechanism (44), wherein the rolls (30) are arranged on the lever mechanism (44).

11. The locker system according to claim 7, wherein the wheels (30) can be blocked and an actuating means for blocking is arranged behind a latchable skirt (48) of the locker system (10).

12. The locker system according to claim 7, wherein the brake is provided on the housing and acts against the ground.

13. A vehicle comprising a loading area (6) and at least one locker system (10) according to claim 1 for receiving valuables.

14. The vehicle according to claim 13, wherein a plurality of locker systems (10-1, 10-2, 10-3, 10-4) is arranged on the vehicle (2), said locker systems (10-1, 10-2, 10-3, 10-4) being movable by means of a rail arrangement (12) in such a manner that neighboring locker system can be accessed at least partially.

15. The vehicle according to claim, wherein a plurality of locker systems (10-1, 10-2, 10-3, 10-4) is provided on the vehicle (2) next to one another and comprises a rail/lifting mechanism so that locker systems arranged on the edge of the vehicle can be lowered or lifted and locker systems arranged in the center can be moved in such a manner that all locker systems can be accessed.
